(19) United States
(12) Patent Application Publication
(10) Pub. No.: US 2009/0013170 A1
(43) Pub. Date: Jan. 8, 2009

(54) Control Device With Configurable Hardware Modules

(75) Inventors: Juergen Becker, Woerth (DE); Joachim Eisenmann, Sussen (DE); Sibylle Cornelia Eisenmann, Sussen (DE); Markus Fabian Eisenmann, Sussen (DE); Tobias Eisenmann, Sussen (DE); Michael Huebner, Karlsruhe (DE); Juergen Luka, Tamm (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 11/885,408

(22) PCT Filed: Feb. 22, 2006
(86) PCT No.: PCT/EP2006/001578

§ 371 Date: Mar. 27, 2008

(30) Foreign Application Priority Data
Mar. 4, 2005 (DE) 10 2005 010 476.2

(51) Int. Cl. G06F 1/24

(52) U.S. Cl. 713/100

(57) ABSTRACT

A control device for controlling components in a vehicle with an interface to an external databus is described. The device includes a hardware module and a memory for making available the data necessary for the data processing. Controller processes are executed by control processes which can be actuated chronologically in parallel with one another, as a result communicating directly via an interface to the databus or with sensors/actuators in order to control components of vehicle. The control device has at least two configurable hardware modules which carry out a plurality of control processes in parallel on the basis of the messages from the databus or on the basis of the control instructions of the control device. A distribution unit is provided for assigning the controller processes which run in parallel to the hardware modules. After the assignment of a controller process to a hardware module, a hardware configuration is firstly loaded into the hardware module in order to newly configure its hardware, and after the allocation of the input data for the controller process, the newly configured hardware module performs the control of the assigned component.

### CROSS REFERENCE TO RELATED APPLICATIONS

This application is a national stage of PCT International Application No. PCT/EP2006/001578, filed Feb. 22, 2006, which claims priority under 35 U.S.C. § 119 to Germany Patent Application No. 10 2005 010 476.2 filed Mar. 4, 2005, the entire disclosures of which are herein expressly incorporated by reference.

### BACKGROUND AND SUMMARY OF THE INVENTION

The invention relates to a device for controlling components in a means of transportation, in particular a vehicle, with an interface to an external databus, a hardware module and a memory for making available the data necessary for the data processing. Controller tasks are executed by control processes which can be actuated chronologically in parallel with one another, and as a result communicate directly via an interface to the databus (2) or with sensors/actuators in order to control components of a vehicle. A method to be executed on this device is also described.

Nowadays, control devices which actuate different components such as, for example, window lifters, a sunroof and other engine components are used in a vehicle. The control devices are networked to one another in order to communicate using an electric databus. Electronic networking in a vehicle is becoming increasingly complex with up to 70 networked control devices.

The processes which are executed by the control devices are chronologically limited control tasks so that a control device for window lifters and a sunroof carries out control tasks in only a relatively short time period compared to the overall running time of the vehicle. During the time frames in which the assigned components are not actuated, the data processing resource of the control device remains unused. On the other hand, the compression of the control tasks on a single passenger compartment control device leads to running time problems, important controller tasks possibly having to wait until preceding controller tasks are executed by the serial data processing processor. In the past this has frequently led to an additional control device being installed in the vehicle for other functionalities. As a result, since a plurality of functions are rarely required simultaneously in the passenger compartment so that a large number of control devices mainly wait in a passive way to be requested by the vehicle occupants.

A first approach leads to the communications tasks and controller tasks being separated within a control device so that a separate processor, in addition to the communications processor, is provided for actuating the components, and as a result it is possible to provide a higher density of controller processes for different components on the same control device. DE 101 604 76 discloses such a control device with two processors in the context of actuating the engine or the transmission, but this is costly in terms of computing time.

In addition, control devices are known which have a conventional microcomputer and whose interfaces are implemented by using a field programmable gate array (FPGA). Such hardware is described in DE 101 396 10. The interface hardware can be reconfigured by using an FPGA. In contrast to the customary inputting of modified software, in this context use is made of the property of wiring the individual memory cells of the FPGA to one another in different ways. In the FPGA, each memory cell is connected to a networking matrix which can be modified by reconfiguration. For example, by using an FPGA it is possible to simulate logic modules, the modules being described in a hardware description language, and by downloading the hardware configuration generated from the hardware description onto the networking controller it is possible to set the wiring between the memory cells in such a way that the desired logic gates are produced. Customary conventional hardware cannot be modified during the running time. In contrast to this, the networking of an FPGA can be set by downloading a further hardware configuration generated from the hardware description onto the FPGA, in such a way that another logic module is produced. In this context, the memory cells of the FPGA are wired as flip-flops and it is possible to construct all the logic units and data processing hardware structures from these flip-flops. By reconfiguring the FPGA it is possible, for example, to produce a data processing unit, which has the structure of a microcomputer, from the present logic gates. It is then possible again to load the conventional software for execution onto this FPGA data processing unit. Such reconfigurable memory units with a data processing functionality, such as logic gates and simulated computing units, are referred to in the following description as a hardware module. The hardware modules are also considered to include the non-reconfigurable data processing units and hardware circuits.

US 2005/027836 A1 discloses a computer system in which program modules are exported into an FPGA. However, this computer system does not relate to use in a vehicle. In addition, Simmler, H.: “Multitasking on FPGA Coprocessors”. XP002319858 describes processes which run in parallel in an FPGA, again when applied in a standard computer system, that is to say without the components of vehicles of the present invention.

A future requirement for the system architecture in a vehicle is to reduce the number of control devices and at the same time increase the capacity utilization of the data processing units.

According to the present invention, a control device is provided with which controller processes in the vehicle can be carried out with high data processing density on hardware modules. In addition, a method to be carried out on the control device is presented.

The embodiments of the invention describe a control device for controlling components in a vehicle. According to the invention, the control device has at least two configurable hardware modules which carry out a plurality of control processes on the hardware modules chronologically in parallel on the basis of messages from the databus or on the basis of the control instructions of the control device. A distribution unit may be provided for assigning the controller processes which run in parallel on the hardware modules, so that, after the assignment of a controller process to a hardware module, a hardware configuration is firstly loaded into the hardware module in order to newly configure its hardware, and after the allocation of the input data for the controller process, the newly configured hardware module performs the control of the assigned component.

According to the invention, the control device has a plurality of hardware modules to which the execution of processes can be assigned in parallel with one another by the distribution unit. The distribution unit makes available here all the requests for the controller process, which is the highest in the waiting memory, so that the execution can be started immediately after the preceding process has been concluded. For this purpose, under certain circumstances it is necessary to make available the hardware configuration in order to reconfigure the affected hardware module for the process to be executed. For example it is possible for just part of the hardware module to be affected, so that a different process continues to run on the remaining chip area of the hardware module. The control device according to an embodiment of the invention has, in addition to the distribution unit, a system for assigning the priority identifier to the respective controller process. It is possible to provide an internal bus which makes available the controller process in electronic form, i.e. its data or information and the hardware configuration, to the affected hardware module. A plurality, for example two to six hardware modules, are then arranged on the internal databus. The distribution unit has an interface to an external databus to which the respective control device is connected. As a result, requests for processes which are signaled to the control device via the external databus can be prioritized immediately and correspondingly processed. Compression/decompression units and flash memories may also be present in the control device. Both the hardware configuration for reconfiguring the modules and software modules, which can be carried out on a hardware module, which is configured as a data processing unit, can be made available in the flash memory.

In addition, information for prioritizing the individual processes can also be made available on the flash memory. A further memory may be provided for initializing and for powering up the configurable memory module, for example the FPGA. This memory can be provided as a separate component or on the FPGA.

As already described, a reconfigurable memory unit such as an FPGA can be provided as the hardware module, but it is also possible to provide a plurality of parallel-connected microcomputers or hardware circuits to which assignments are made on account of the prioritization process. This produces a parallel data processing system to which assignments are made utilizing the distribution unit using the different processes, and which is activated in such a way that the functional capacity utilization is correspondingly uniform and as effective as possible.

With the FPGA implementation or the implementation utilizing a configurable hardware module it is particularly advantageous that important databus data can be processed in real time with response times of less than one millisecond. In this time, a high priority process is made available and the hardware module is, if appropriate, reconfigured in accordance with a hardware configuration, and the execution takes place in this time so that the hardware module is available for further processes.

In the method according to the present invention, a priority identifier can be allocated dynamically, and when there are different traveling situations or operator control situations for the vehicle, different priorities are allocated to the various processes. This prioritization method for controller processes makes it possible to select, from a plurality of controller processes stored in a waiting memory, those which are most important or most critical in terms of time, and to assign them to a hardware module for execution. The prioritization method is particularly suitable for distributing controller processes to be executed on a plurality of hardware modules for data processing. In this embodiment, a distribution unit which is assigned to the waiting memory assigns the sequenced controller processes in accordance with their prioritization to the different hardware modules for data processing.

The hardware modules may be either conventional data processing units, such as logic circuits or microcomputers, or may be reconfigurable memory units such as, for example, an FPGA. The method selects from the waiting memory the process with the highest priority and assigns it to one of the hardware modules which are available in parallel, so that the fastest possible, reliable execution can be carried out.

Particularly, if the hardware modules are embodied as reconfigurable hardware, it is possible to generate flexible, adaptable electronic modules. It is also possible to provide in this embodiment a plurality of computing units that are produced within one hardware module by configuring one FPGA. For this purpose, a hardware configuration is loaded onto the FPGA each time, in order to reconfigure it. The controller process is then carried out on this FPGA and, after its execution, the FPGA can then be configured for the next process which is assigned to it. The partially dynamic reconfiguration of such hardware modules is controlled by using a preprogrammed hardware configuration which is stored in a small library, for the different configurations. Depending on the time when a process is requested, the corresponding hardware configuration is then loaded into the FPGA, the latter is reconfigured and the controller process is executed thereon.

The exemplary method according to the invention in conjunction with the expanded functionality of the hardware modules permits the number of control devices within a control device architecture to be reduced in a vehicle. The multiple use of the different hardware modules for different controller processes permits the overall necessary chip area to be decreased. Genuine parallel and decoupled processes are possible on one chip or a single hardware module, with chip area parts being reconfigured and processes being completely executed on these chip area parts. Functions which can be tested independently of one another and re-used are produced. If, for example, a window lifter is activated and an FPGA is configured on a hardware module, the same topology can be used, if appropriate, for controlling a further window lifter. The reconfiguration of the hardware modules produces a way of making available functions in accordance with requirements, as a result of which there is no need for unnecessary management of resources.

In one advantageous embodiment of the invention, differentiation into at least two states is performed with respect to the allocation of the dynamic priority identifier. In a first operating state of the vehicle, if the latter is, for example, moving on a road, different priority identifiers are allocated for the same component or the same process than if the vehicle is in the stationary state, in which it is parked or at least not moving in terms of traffic.

This different allocation of priority identifiers allows, for example, a high prioritization to be allocated to a sunroof arrangement in a state of rest so that this is executed with preference, while in the traveling state there may be a waiting time of several milliseconds until the process is executed when the sunroof is activated, because of its lower priority. The driver will hardly be aware of the relatively short waiting time, while the hardware modules can in the meantime execute high priority processes such as, for example, the transmission and actuation of safety-related signals, for example the triggering of an airbag. As a result, a relatively low priority identifier can be assigned to the process for the sunroof in the operating state of the vehicle, so that the process for activating the sunroof is not carried out until after higher priority processes. For this purpose, it is possible to provide for each process a certain period of time within which this process has to be executed. After this period of time has expired, either the priority identifier can be increased or the process actually carried out immediately.

Likewise, a system for warning about a break-in and/or theft can have a high dynamic priority identifier in the state of rest, while in the operating state or driving state of the vehicle, the system for warning about a break-in and/or theft has a low priority identifier, or even none at all. The lack of a priority identifier can then means that the process is not carrier out at all in this driving state.

By making available the waiting memory it is possible for all the processes to be set there and sorted according to the priority identifier. The process with the highest priority identifier is then executed by the data processing unit or the hardware module which makes available the next data processing resource. If, for example, a plurality of hardware modules are provided in parallel, the processes are assigned to them in succession depending on their priority. In the case of reconfigurable memory devices, for example an FPGA, certain parts of the FPGA can be reconfigured into logic circuits by downloading a hardware configuration so that the controller process can be carried out automatically using hardware. For this reason, in the exemplary method according to the invention, each process is also assigned a specific hardware configuration in order to be able to reconfigure the hardware module, if appropriate.

There are various possible ways of advantageously configuring and developing the teaching of the present invention. Additional embodiments of the invention will be described with reference to the following explanations and drawings. An embodiment of the device according to the invention is illustrated in the drawings.

Other objects, advantages and novel features of the present invention will become apparent from the following detailed description of the invention when considered in conjunction with the accompanying drawings.

### BRIEF DESCRIPTION OF THE DRAWINGS

In the drawings:

FIG. 1 shows a schematic illustration of a control device according to an embodiment of the invention with four hardware modules,

FIG. 2 shows a flow chart for an exemplary method of selecting a specific hardware module for executing a control process, and

FIG. 3 shows schematically an exemplary distributor unit of the control device with a context memory for ensuring the fault-free sequence when a control process is assigned to a hardware module.

### DETAILED DESCRIPTION OF THE DRAWINGS

The exemplary control device 1 is connected in an electrically conductive fashion to other control devices of a vehicle, in particular of a motor vehicle, via an external databus, for example a CAN bus 2. The incoming bus messages from the other control devices (not illustrated) are assigned to a distributor unit 6 by the databus 2 via the input/output interface 3 over an input channel 4 or the output channel 5. In the distributor unit 6, the messages of the external databus 2 are stored and are made available for the data processing in the control device 1.

The controller processes resulting from the messages of the databus 2 are assigned by the distributor unit 6 via an internal databus 7 to the various hardware modules 8,9,10 and 11 which are all available for executing the control processes. If appropriate, the distributor unit 6 prioritizes the control processes which result from the messages of the databus 2 and, if appropriate, from sensors and actuators connected directly to the control device 1. An input/output unit 12 for the internal databus 7 assigns the messages output from the distributor unit 6 to the hardware modules 8 to 11 via the internal databus 7. The control device 1 also has an initialization module 13 which obtains, from an internal or external flash memory 14, the initialization data for the various hardware modules 8 to 11 and also information for configuring the hardware modules 8 to 11.

The exemplary hardware modules 8 to 11 are preferably embodied as configurable memories which can reconfigure their hardware, for which purpose the necessary hardware configuration is downloaded from the flash memory 14, and the connecting structure between the memory cells of each hardware module 8 to 11 can be reconfigured on the basis of this hardware configuration. As a result, the hardware modules 8 to 11 have chip areas configurable, for example, to serve as memories, form logic gates or else simulate a microcomputer which then carries out a controller process by utilizing a piece of software. However, the usual case will be that an electrical circuit is simulated on the chip areas of the hardware modules 8 to 11, in accordance with the hardware configuration, and the circuit then carries out the controller process without additional software.

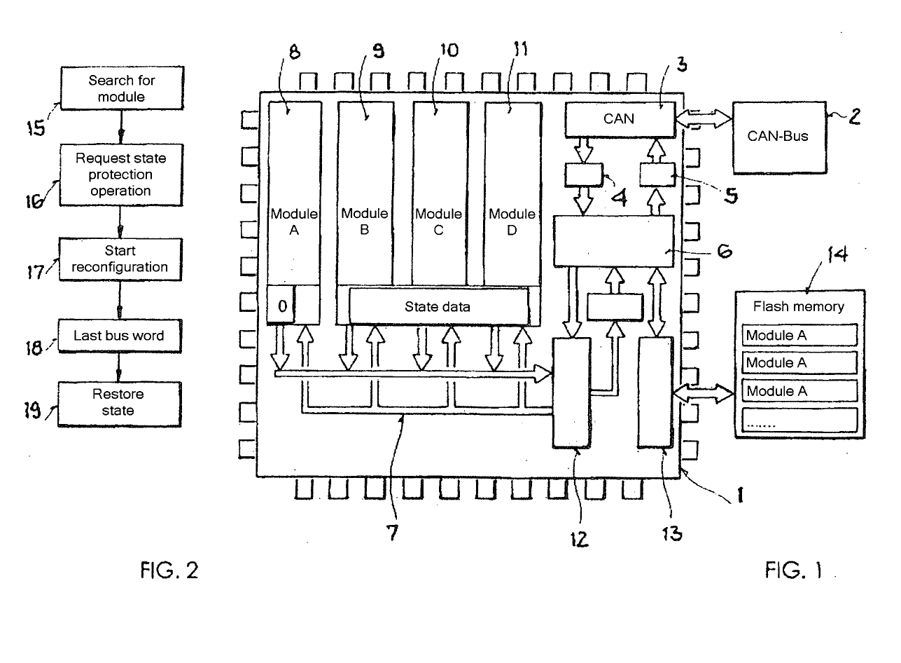

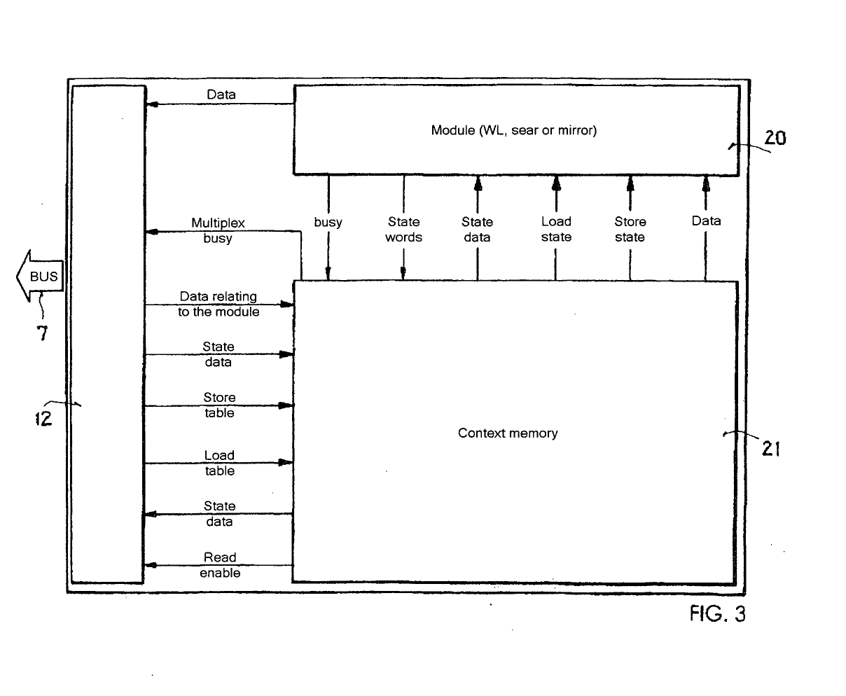

FIG. 2 shows an exemplary method according to the invention, in which a control process is assigned to the various hardware modules 8 to 11. In the simplest case, each hardware module can simulate precisely one electrical circuit on the basis of the hardware configuration, and the control processes are executed in accordance with the initial conditions. After the end of a control process, the hardware module 8, for example, can be enabled again for a new control process. The hardware module 8 reconfigures itself, if appropriate, on the basis of the information of the distributor unit 6 and the information stored in the flash memory 14 or on the semiconductor chip of the FPGA 8 itself, and carries out another control process for another component in the vehicle.

As shown in FIG. 2, in step 15 the distributor unit 6 will firstly select a suitable free hardware module of the hardware modules 8 to 11, and carry out a state protection operation 16 so that the control process previously executed on the selected hardware module 8 to 11 and its data are not lost. After the hardware module 8, 9, 10 or 11 has been enabled, the free hardware module 8, 9, 10 or 11 can be reconfigured at 17. In a step 18, the bus word which is present on the internal databus 7, i.e. the last message transmitted via the internal databus 7, is determined and stored so that after the reconfiguration of the hardware module 8 or after the execution of the intermediate process, the bus word can be transmitted onto the internal bus 7 again, when the interrupted process is resumed. After the control process has been concluded the state of the hardware module which was present before the process was executed is restored in 19.

The exemplary process illustrated in FIG. 2 is suitable in particular if a control process which is to be carried out with high priority has to be performed, even though a relatively slow control process is still being carried out on one of the hardware modules 8 to 11. The state which was last present in the respective hardware module 8, 9, 10 or 11 is then buffered, the control process with high priority is carried out, and after the control process with high priority has run, the state last provided on the hardware module 8 to 11, as it was before the interruption, is restored. In this way, the slower control process can be continued starting from a protected state.

FIG. 3 shows an exemplary state data management system as a component of a hardware module 8, 9, 10 or 11 with the connection to the internal bus 7 to which the control processes 20, such as that of controlling the seat, mirror or window lifter, for example, are connected. New state data can be transmitted to the context memory 21 via the input/output module 12 over the internal bus 7. In the context memory, parameters and input/output data for the hardware modules 8 to 11 which are necessary to start a control process after the reconfiguration of a hardware module are stored. The state data management system additionally has a context memory 21 in which the respective state for specific events is stored again for each hardware module 8 to 11. Furthermore, a list or table which records input and output data of the hardware module 8, 9, 10 or 11 and also logs specific states of the respective hardware modules 8 to 11 is stored in the context memory 21. The state tables can be converted into the bus protocol of the internal bus 7 via the input/output unit 12 for the bus and can be transmitted to the hardware modules 8 to 11 via the internal databus 7.

If, for example, a control process is carried out on one of the hardware modules 8 to 11, and if the control process is interrupted, the state data is stored in the context memory 21 and a high priority control process can be carried out, if appropriate. After the conclusion of the process, the state data stored in the context memory 21 can then be transmitted to the hardware module 8 to 11, as a result of which the control process can be interrupted in order to carry out another process, and can be carried on again to resume later from the same state.

The exemplary device 1 can be implemented on a single semiconductor chip which implements the hardware modules 8 to 11 and the other electrical circuits in chip segments. The control device here can have a large area FPGA which simulates the necessary components.

The following list of reference numerals may be useful in better understanding the above discussion and the drawings.

| | |
|---|---|
| 1 | Control device |
| 2 | External databus |
| 3 | Input/output unit |
| 4 | Input channel |
| 5 | Output channel |
| 6 | Distribution unit |
| 7 | Internal databus |
| 8-11 | Hardware modules |
| 12 | Input/output unit for 7 |
| 13 | Initialization module |
| 14 | Flash memory |
| 15-19 | Method steps |
| 20 | Input/output module |
| 21 | Context memory |

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. A control device for controlling components in a vehicle with an interface to an external databus, comprising:
a memory for making available the data necessary for the data processing, controller processes being executed by control processes actuatable chronologically in parallel with one another, thus communicating directly via an interface with one of the external databus and sensors/actuators, to control components of the vehicle;
at least two reconfigurable hardware modules of the control device which carry out a plurality of control processes thereon, chronologically in parallel in response to one of messages from the external databus and control instructions of the control device;
a distribution unit for assigning the controller processes which run in parallel to the at least two reconfigurable hardware modules, wherein, after assignment of a controller process to a first of the reconfigurable hardware modules, hardware configuration is firstly loaded into the first reconfigurable hardware module to newly configure its hardware, and wherein, after the allocation of the input data for the controller process, the configured first reconfigurable hardware module controls the assigned component; and
a small library for storing a preprogrammed hardware configuration for the different configurations, to effect a partially dynamical control of the reconfiguration of the at least two reconfigurable hardware modules,
wherein, corresponding to times when a process is requested, the distribution unit loads the hardware configuration into the first reconfigurable hardware module, so that the latter is reconfigured and the controller process is executed thereon in the reconfigurable hardware module.

12. The control device as claimed in claim 11, wherein one of the reconfigurable hardware modules comprises a chip area divisible into at least two hardware areas by being configured using a hardware configuration downloadable from a memory, wherein a controller process is executable on a first hardware area, and at least one further controller process is executable on a further hardware area, and wherein the reconfigurable hardware module is reconfigurable so that, in order to carry out the further controller process, the hardware areas or portions thereof are configured jointly in order to control the assigned components.

13. The control device as claimed in claim 12, wherein the reconfigurable hardware module is configured to carry out a first controller process so that one of a plurality of identical components, which can be activated chronologically in parallel, can be actuated, and wherein, after the first controller process has been concluded, the configured hardware module is configured and used to control another of the identical components of the vehicle so that the components receive sequentially one after the other a start signal from the reconfigurable hardware module, and further wherein, after the start process has been executed, one of the reconfigurable hardware modules is reconfigurable utilizing the distribution unit to output the stopping/ending control process for the identical components.

14. The control device as claimed in claim 13, wherein the identical components operate simultaneously after the actuation by the reconfigurable hardware module and receive a stopping/ending signal from the reconfigurable hardware module in a chronological sequence in a time-division multiplex operating mode of the same reconfigurable hardware module.

15. The control device as claimed in claim 11, further comprising a state memory storing information relating to a state, a location and a position of a component, wherein, during assignment of the controller processes to a reconfigurable hardware module, the distribution unit transmits the information from the state memory as input data to the reconfigurable hardware module.

16. A method for controlling a plurality of components in a vehicle, the method comprising the acts of:
in a control device, executing a first control process for a first component and a second control process for a second component, each control process being chronologically limited to control the assigned component, wherein each control process is determined by a start time and an end time, the start time being defined by a triggering event;
executing on a same control device processes which can be carried out in parallel, wherein, in order to carry out each of the processes, a hardware module comprising configurable memory/logic cells is configured by a hardware configuration assigned to the control process being loaded onto the hardware module from a memory;
subsequently executing a first one of the control processes;
after the execution, a further process being selected and an associated hardware module composed of configurable memory/logic cells being configured;
carrying out the associated control process on the hardware module, and with a distributor unit firstly selecting a suitable free hardware module of the hardware modules;
carrying out a state protection operation of the data so that the control process previously executed on the selected hardware module and its data are preserved; and
reconfiguring the free hardware module after enabling the hardware module, wherein after execution of the intermediate process, the state of the hardware module which was present before the process was executed is restored.

17. The method as claimed in claim 16, further comprising the acts of dividing the hardware module into at least two hardware areas configured with a hardware configuration downloaded from a memory,
wherein a first controller process is carried out on the first hardware area, and a second controller process is carried out on the second hardware area, and
wherein afterwards the hardware module is reconfigured so that, in order to carry out a further controller process, both hardware areas or parts thereof are jointly configurable to control an assigned component.

18. The method as claimed in claim 17, further comprising the acts of configuring a hardware module to carry out a first controller process so that one of a plurality of identical components, actuatable chronologically in parallel, are actuated,
wherein, after the first controller process has been concluded, the configured hardware module is further configured and used to control another of the identical components of the vehicle, so that the components receive sequentially one after the other a start signal from the hardware module, and
wherein, after a start process has been executed, one of the hardware modules is reconfigured using the distribution unit to output the stopping/ending control process for the identical components.

19. The method as claimed in claim 18, further comprising the act of simultaneously activating the identical components after the actuation by the hardware module, and receiving a stopping/ending signal from the hardware module in a chronological sequence in a time-division multiplex operating mode thereof.

20. The method as claimed in claim 16, further comprising the act of storing in a state memory information relating to the state, the location or the position of a component, and wherein, during the assignment of the controller processes to a hardware module, the distribution unit transmits the information from the state memory as input data to the hardware module.

21. The control device as claimed in claim 13, wherein the plurality of identical components comprises a plurality of window lifter motors of the vehicle.

22. The method as claimed in claim 18, further comprising the act of configuring a hardware module to carry out a first controller process, so that one of a plurality of window lifter motors of the vehicle are actuated.
